(19) United States
(12) Patent Application Publication
(10) Pub. No.: US 2004/0210631 A1
(43) Pub. Date: Oct. 21, 2004

(54) Method and apparatus for accessing legacy data in a standardized environment

(76) Inventors: Michael L. Asher, Green Grove Springs, FL (US); Hossein Eslambolchi, Los Altos Hills, CA (US); Charles C. Giddens, Conyers, GA (US); Christopher Rollin Giles, Auburn, AL (US); Harold Jeffrey Stewart, Alpharetta, GA (US)

Correspondence Address: AT&T CORP., P.O. BOX 4110, MIDDLETOWN, NJ, 07748, US

(21) Appl. No.: 10/417,935

(22) Filed: Apr. 17, 2003

(51) Int. Cl. G06F 15/16

(52) U.S. Cl. 709/203

(57) ABSTRACT

In accordance with the teachings of the present invention, a method and apparatus is presented for accessing data using Web Services. A prototype object is defined which describes data. The prototype object is defined in a Web Services Description Language (WSDL) document using a class. In one embodiment of the present invention, the class is implemented with a struct data type. In an alternate embodiment of the present invention, the class is implemented with a class data type. The WSDL document is used to operate a Web Service, which accesses the data and generates objects compliant with the class.

### BACKGROUND OF THE INVENTION

1. Field of the Invention

This invention relates to data management. Specifically, the present invention relates to data access in information systems.

2. Description of the Prior Art

Conventional information networks include a variety of computers connected through a communication infrastructure. The computers often include databases that store information and the communication infrastructure serves as a vehicle for communicating the information. As such, the combination is considered an information network.

Information networks are not new. Information networks have been evolving over many years and are currently continuing to evolve and grow. Unfortunately, information networks have not evolved uniformly.

A conventional information network may include both legacy systems and new systems. For example, even the smallest information networks may include older hardware and software communicating with newer hardware and software. Further, the information infrastructure may include legacy communication devices intermixed with more modern communication devices. Irrespective of whether the system is a legacy system or a modern system, all the systems in the network have to communicate in order for the information network to function properly. For example, a computer or communication device using legacy software or hardware has to be able to communicate with a computer or communication device that operates based on newer hardware and software.

To address the issue of compatibility between systems (i.e., legacy and new systems), a variety of hardware, software, and communication standards have been developed. Not only do these standards provide for interoperability between systems, but these standards also address the issues of forward and backward compatibility between systems. Therefore, in theory, the various standards, whether directed at operating systems, hardware, software, communication methodologies, etc., enable network components that conform to the standards to interoperate.

A variety of information system standards are currently in use. For example, on the Internet (i.e., World Wide Web or Web), Hypertext Markup Language (HTML) is used as a standard to define how information is displayed in a graphical user interface (GUI). Transmission Control Protocol/Internet Protocol (TCP/IP) is used as a standard to communicate information across the Internet.

A variety of technologies and development tools have been developed to address the issue of compatibility between standards. For example, in one approach, the rules required to process information are communicated with the information. As such, a computer that receives the information may process the information based on the rules that arrive with the information. Extensible Markup Language (XML) is such a technology. The data (i.e., known as metadata) needed to understand the XML message is communicated with the XML message. Although this approach requires additional bandwidth, the approach does address the issue of interoperability and compatibility.

However, although XML does solve some of the issues associated with information networks, it does not solve all of them. For example, some legacy systems do not implement XML parsers and therefore cannot interpret XML. Further, since the XML standard continues to evolve, some legacy systems are not able to interpret the latest version or the most advanced implementations of XML. As a result, there are many legacy systems that are connected to the network that would require significant development and redeployment of data to make them accessible through XML. Further, since an XML document carries the rules required to understand the document, XML requires addition bandwidth in information networks where bandwidth is often limited.

Thus, there is a need for a method of accessing legacy data in information networks. There is a need for a standards-based method and apparatus that enables the acquisition of legacy data, but still facilitates interoperability between systems. There is a need for a standards-based method and apparatus for accessing legacy data that minimizes the bandwidth associated with most standards implementations.

### SUMMARY OF THE INVENTION

A method and apparatus for accessing legacy data in a standards-based environment is presented. In one embodiment of the present invention, a Web Services implementation is presented, which provides a low-bandwidth approach to accessing legacy data in a standardized networking environment. A Web Services framework is implemented. A variety of systems including legacy systems are identified and accessed using the Web Services framework. A Web Services Description Language (WSDL) document is defined. The WSDL document includes a class definition. As such, data stored on legacy systems that are unable to interpret high-level language data types, such as Extensible Markup Language (XML) data types, may still be accessed within the Web Services framework.

A method of accessing information comprises the steps of identifying a service; and communicating with the service using a service description, the service description including a class.

A memory comprises Web Services Description Language compliant information, the Web Services Description Language compliant information including class information, the class information implemented with a structured data type defined by the class information.

A method comprises the steps of receiving Web Services Description Language compliant information, the Web Services Description Language compliant information including a class; generating a request to a Web Service in response to receiving the Web Services Description Language compliant information; and receiving a response from the Web Service, the response including at least one object compliant with the class.

A method comprises the steps of receiving Web Services Description Language compliant information including a class; operating a Web Service in response to receiving the Web Services Description Language compliant information including the class; and generating at least one object implemented in accordance with the class in response to operating the Web Service compliant information including the class; and generating at least one object implemented in accordance with the class in response to operating the Web Service.

### BRIEF DESCRIPTION OF THE DRAWINGS

FIG. 1 displays one embodiment of a Web Services architecture implemented in accordance with the teachings of the present invention.

FIG. 2 displays a computer implementing the teachings of the present invention.

FIG. 3 displays a flow diagram implementing a method of the present invention.

FIG. 4 displays a development diagram implementing the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In one embodiment of the present invention, Web Services as promulgated in the World Wide Web Consortium (W3C), Working Draft 14 Nov. 2002 (w3.org/TR/2002/WD-ws-arch-20021114) are implemented. Web Services are defined as the programmatic interfaces used for application-to-application communication over the World-Wide Web (web). Web Services provide a standard means of communication among different software applications running on a variety of platforms and/or frameworks. Web Services may be implemented with Extensible Markup Language (XML) based standards. Selected Web Services related standards and components include Simple Object Access Protocol (SOAP), SOAP Version 1.2 Part 1: MessagingFramework W3C Candidate Recommendation 19 Dec. 2002 (w3.org/TR/soap12-part1/); Web Services Description Language (WSDL), Web Services Description Language (WSDL) Version 1.2 W3C Working Draft 24 Jan. 2003 (w3.org/TR/wsdl12/); Universal Description Descovery and Integration Web Services (UDDI) Version 3.0 Published Specification, 19 Jul. 2002, (uddi.org (v3.00-published-20020719)); Hypertext Transfer Protocol (HTTP)—HTTP 1.1, IETF RFC 2616, 1999; etc.

It should be appreciated that while a specific implementation of Web Services will be described and discussed in the present invention, variations of this implementation as promulgated by the W3C are still within the scope of the present invention. Further, consistent with all standards, various versions of the foregoing standards will be promulgated and distributed in the future. The method and apparatus of the present invention is applicable to the underlying model and architecure of the Web Services framework and is therefore within the scope of future versions of the Web Services standard.

Web Services are typically based on XML. SOAP is an XML-based protocol for exchanging and communicating information between computers. UDDI is a directory for registering and finding Web Services. WSDL describes how one software system can connect and utilize the services of another software system over the Internet. In the present invention, a class is implemented in a WSDL document. The class is used to create objects and access data from XML-compliant systems. In an alternate embodiment of the present invention, the class is used to create objects and access systems that are not compliant with XML (i.e., non-XML compliant data). The class is a definition, a paradigm, or a template used to create objects; therefore, a class contains the common characteristics of objects implemented in accordance with the class. As such, the objects implemented in accordance with a class share a common template.

In accordance with the teachings of the present invention, service descriptions and definitions, such as service interface and implementation descriptions and definitions, may be defined. In accordance with one embodiment of the present invention, the service descriptions and definitions are defined in a WSDL Document. WSDL documents perform three functions. WSDL documents (1) identify the contents and data types of messages; (2) define the operations performed on messages; and (3) identify the protocol used for transporting and exchanging messages with other operations over the network. As such, the WSDL document provides the descriptions and the definitions necessary to perform the Web Services. In one embodiment of the present invention, the WSDL document as defined by the W3C includes service interface definitions and service implementation definitions. The service interface definitions allow common industry standard service types to be defined and implemented by multiple service implementers. The service implementation definition describes how a service interface is implemented by a given service provider. It should be appreciated that although WSDL is described as being implemented in a document, WSDL may be stored in a memory or WSDL may be implemented as part of a communication data stream communicated across a network. As such, information that is stored in a memory, stored in a document, communicated as a signal or datastream may be WSDL-compliant information.

A WSDL document is defined by six elements. The six elements include (1) a definitions element; (2) a data types element; (3) a message element; (4) a port type element; (5) a binding element; and (6) a service element. The service interface definition is implemented with a service element and a definitions element. The service implementation definition is implemented with a binding element, a port type element, a message element and a data type element.

The definitions element is the root element (i.e., first element) of a WSDL document. The definitions element defines the name of A Web Service, declares multiple namespaces used throughout the remainder of the WSDL document, and contains all of the other elements. The data types element describes all of the data types that will be used between a client and a server. The message element describes a message, such as a message request or a message response. The message element defines the name of the message and may contain other message elements, which may refer to message parameters or message return values. The port type element combines multiple message elements to form a complete one-way or round-trip operation. For example, a port type element can combine a request and response into a single operation. In addition, the port type element may define multiple operations. The binding element describes specifically how the service will be implemented on the communication medium (i.e., optical medium). The service element defines the address for invoking a service. The service element is typically implemented with a Universal Resource Locator (URL).

In addition to Web Services technology, the method and apparatus of the present invention implements object-oriented technology. In object-oriented technology, a class is a self-contained entity that may contain both data and procedures to manipulate the data. Therefore, a class is an entity that can save data and may include a number of procedures to either examine or affect the data. An object may include members, which specifically define and characterize the object. A class is a blueprint for objects and describes how these objects are structured internally. A class defines a data structure. Objects of the same class have the same definition both for their procedures and for their data. An object is an instance created from a class. The class describes the behavior and data (i.e., structure) of the instance, while the current state of the instance is defined by the operations performed on the instance.

In one embodiment of the present invention, a class is implemented in a WSDL document. A specific class is defined. The instances of the class include simple objects. In one embodiment of the present invention, the simple objects have three members. The first member is a string data type. The second member is an integer data type. The third member may be an object data type. When a client environment interprets an object, which is an instantiation of the class (i.e., described in the WSDL document), the new object is exposed in the client code as if it were native to the development language of the client machine. It should be appreciated that the class may be implemented in many forms. For example, if an object represents a customer, then a class is prototyped with each object representing a simple data type that characterizes the customer.

In one embodiment of the present invention, a class is implemented in the WSDL document using a “struct” data type, which includes members of a primitive data type. A “struct” data type is an aggregate data type. It allows multiple members to be grouped together and named using a tag. Each item in a “struct” data type is called a member and may have any data type, including other data structures and unions. In a second embodiment of the present invention, the class is implemented in the WSDL document using a “class” data type, which includes members. A “class” data type is an aggregate data type. It also includes multiple members, which are grouped together and named using a tag. Each item in a “class” data type is called a member and may have a data type, including other data structures and unions. It should be appreciated that an object created in accordance with the class, irrespective of the implementation mechanism, is within the scope of the present invention. For example, the implementation mechanism may include any structured data type implemented in accordance with the class.

A structured data type is a type in which each value is a collection of component items. The entire collection has a single name and each component can be accessed individually. For example, a struct data type may take the format of:

Struct StructName {

Member 1
Member 2
}

where “StructName” is the name of the structure and “Member 1” and “Member 2” are members of the structure. In one embodiment of the present invention, a structured data type is defined for accessing customers such as:

public struct CustomerStruct
{
public string ID;
public string CustomerName;
public string HQCity;
public string HQState;
}

In the foregoing example, CustomerStruct data structure is implemented with “struct” (i.e., struct data type). CustmerStruct is a structured data type that includes members, such as ID, CustomerName, HQCity, and HQState. Each of these members are defined as strings. In addition, both the data structure (i.e., CustomerStruct) and the members (i.e., ID, CustomerName, HQCity, and HQState) are public, which means that they are accessible outside of the computer program that is running the CustomerStruct data structure.

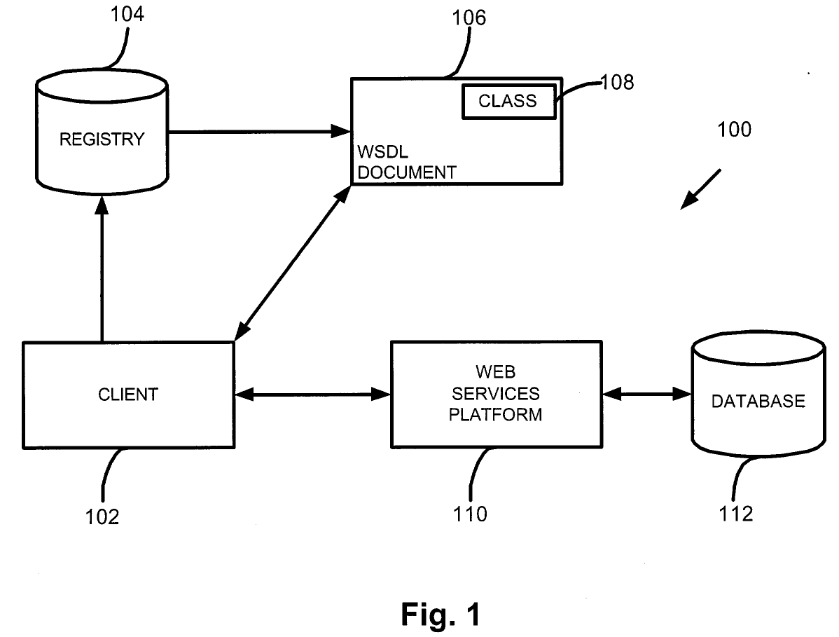

FIG. 1 displays one embodiment of a Web Services architecture 100 implemented in accordance with the teachings of the present invention. A client is shown at 102. The client 102 is capable of implementing methods (i.e., performing process steps). The client 102 may be implemented in hardware, software, or a combination of hardware and software. In one embodiment of the present invention, the client 102 is a computer operating under the direction of software.

The client 102 is in communication with a registry 104. The registry 104 is used to advertise Web Services. The registry 104 stores the location of Web Services on the network. For example, the registry 104 may store the Universal Resource Locator (URL) locations of various Web Services. Both the client 102 and the registry 104 communicate with the WSDL document 106. Therefore, a class 108 may be communicated from the WSDL document 106 to the client 102. The client 102 is in communication with a Web Services platform 110. The Web Services platform 110 stores methods that may be initiated by the client 102. In one embodiment of the present invention, the Web Services platform 110 may be a server platform. The Web Services platform 110 is in communication with a database 112. The database 112 may include XML-compliant data or non-XML-compliant data (i.e., legacy data).

Each of the communication pathways between the network components, such as the client 102, the registry 104, the WSDL document 106, the database 112, may each occur across a single network. In an alternate embodiment of the present invention, each component may communicate across separate networks. For example, the Web Services architecture 100 may be implemented in a packet-switched network, a circuit-switched network, etc.

During operation, the client 102 queries the registry 104 to locate a specific Web Services, such as the service that acquires data (i.e., legacy, non-XML-compliant). The registry 104 refers the client 102 to the WSDL document 106. The client 102 accesses the WSDL document 106. A class 108 has been defined in the WSDL document 106. The WSDL document 106 provides data (i.e., class) to enable the client 102 to communicate with the Web Services platform 110. The client 102 sends a message request, such as a SOAP message request, an HTTP message request, etc., to the Web Services platform 110. In response to the request, the Web Services platform 110 is able to query the database 112. The Web Services platform 110 then returns a message response, which includes data (i.e., legacy, non-XML-compliant, non-compliant) to the client 102.

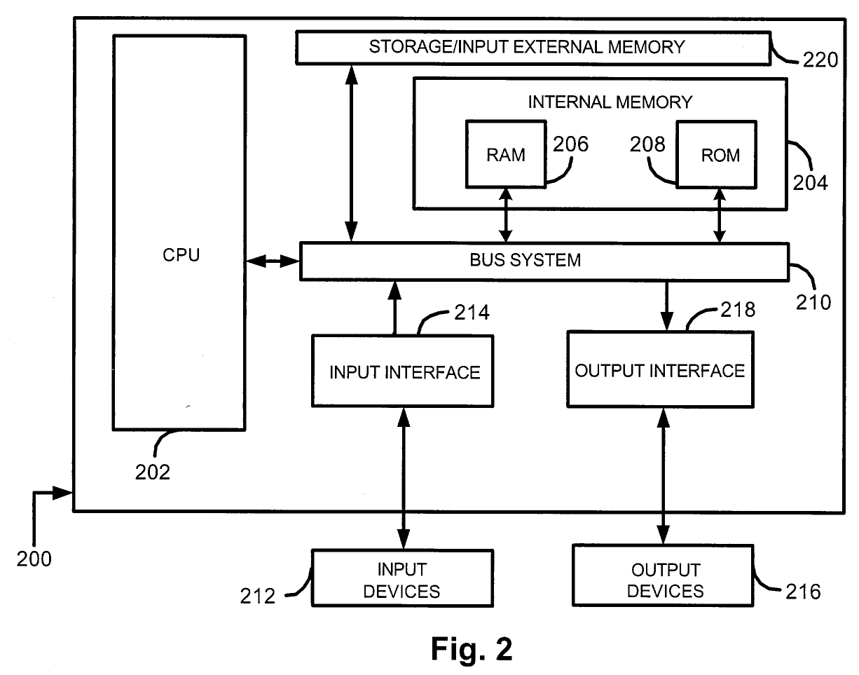

In FIG. 2, a block diagram of computer 200 is shown. In one embodiment of the present invention, client 102, registry 104, Web Services platform 110, and database 112 may be implemented with computer 200. A central processing unit (CPU) 202 functions as the brain of computer 200. Internal memory 204 is shown. The internal memory 204 includes short-term memory 206 and long-term memory 208. The short-term memory 206 may be Random Access Memory (RAM) or a memory cache used for staging information. The long-term memory 208 may be a Read Only Memory (ROM) or an alternative form of memory used for storing information. In one embodiment of the present invention, a short-term memory, such as RAM 206, may be a display memory and used for storing a GUI for display on a monitor. A storage memory 220, such as a hard drive, is also shown. A bus system 210 is used by computer 200 to communicate information from short-term memory 206, long-term memory 208, storage memory 220, input interface 214, output interface 218, and CPU 202. In addition, the bus system 210 may be connected to interfaces that communicate information out of computer 200 or receive information into computer 200.

Input devices, such as a joystick, a keyboard, a microphone, a communications connection, or a mouse, are shown as 212. The input devices 212 interface with computer 200 through an input interface 214. Output devices, such as a monitor, speakers, communications connections, etc., are shown as 216. The output devices 216 communicate with the computer 200 through an output interface 218.

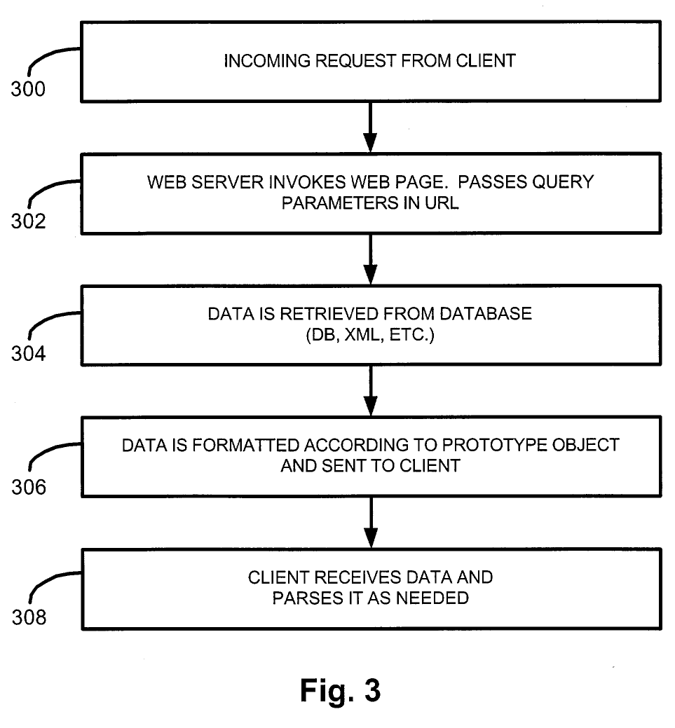

FIG. 3 displays a method of operating in accordance with the teachings of the present invention. In FIG. 3, an incoming request is received from a client as stated at 300. The incoming request invokes a web page and passes query parameters received in a URL from the client as stated at 302. The requested data is retrieved from a database as stated at 304. The data is accessed using Extended Markup Language (XML), Structured Query Language (SQL), etc. The data is formatted according to a prototype object and sent to the client as shown at 306. The client then receives data communicated from the server and parses the data as stated at 308.

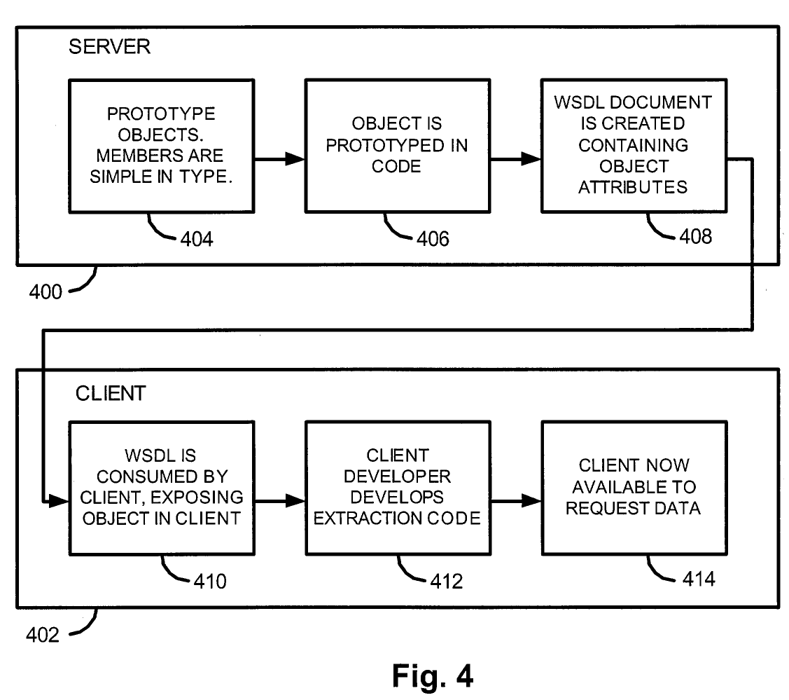

FIG. 4 details a client and a server development process implemented in accordance with the teachings of the present invention. In FIG. 4, a server 400 and a client 402 are presented. An object is prototyped in the server object's computer instructions (i.e., code). A WSDL document is generated from the server-side code and denotes all interfaces, members, and functions of that server object. The members of the prototype object are of a primitive type (string, integer, etc.). For example, the members may be implemented with a struct data type or a class data type. The object is prototyped in code as stated at 406. A WSDL document is created containing a class definition (i.e., implemented with objects) as stated at 408. The client 402 accesses the WSDL document 408. The WSDL document 408 is processed (i.e., consumed) by the client 402, exposing the object in the client 402 as stated at 410. The client developer develops extraction code as stated at 412 and the client 402 is available to request data as stated at 414.

A sample server-side code implemented in accordance with the teachings of the present invention is given as follows:

public struct CustomerStruct
{

public string ID;
public string CustomerName;
public string HQCity;
public string HQState;

}.

[Web Method]

public CustomerStuct [ ] CustomerSearchForCustomers (string CustomerName)
{

// vars
CustomerStruct [ ] cs;
. . .
object CustomerCountScalar = cmd.ExecuteScalar ( );
int CustomerCount = Convert.Tolnt32 (CustomerCountScalar);
cs = new CustomerStruct [CustomerCount];
. . .
while (rdr.Read( ))
{

cs[Counter].ID = isDBNull (rdr, 0);
cs[Counter].CustomerName = isDBNull (rdr, 1);
cs[Counter].HQCity = isDBNull (rdr, 2);
cs[Counter].HQState = isDBNull (rdr, 3);
Counter++;

}
. . .
return (cs);

}

A sample client-side code implemented in accordance with the teachings of the present invention is given as follows:

CustomerSearching cs = new localhost.CustomerSearching ( );
CustomerStruct [ ] cstruct = cs.CustomerSearchForCustomers (“Metra%”);
foreach (Iocalhost.CustomerStruct _cs in cstruct)
}

. . .

}

The foregoing computer instructions may be implemented in a computer. For example, the foregoing client-side code may be implemented on client 102 of FIG. 1 and the foregoing server-side code may be implemented on Web Services platform 110 of FIG. 1. As such, the Web Services platform 110 of FIG. 1 would access the database 112 of FIG. 1. The output is then communicated back to client 102 and interpreted in client 102. Client 102 may then produce objects implemented with the format (i.e., class) given below:

(1) Customer

ID: 889001

Name: Company X

HQ City: Holly Hill

HQ State: FL

(2) Customer

ID: 343388

Name: Company X

HQ City: Holly Hill

HQ State: FL

(3) Customer

ID: JF3392

Name: Company X

HQ City: Holly Hill

HQ State: FL

(4) Customer

ID: 889001

Name: Company X

HQ City: Paramount

HQ State: CA

It should be appreciated that each object (i.e., 1, 2, 3, 4) is implemented in accordance with the class in the WSDL document.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A method of accessing information comprising the steps of:
identifying a service; and
communicating with the service using a service description, the service description including a class.

2. A method of accessing information as set forth in claim 1, wherein the service description is implemented in accordance with a service description language.

3. A method of accessing information as set forth in claim 1, wherein the service description is compliant with Web Services Description Language.

4. A method of accessing information as set forth in claim 1, wherein the step of identifying the service is performed using a registry.

5. A method of accessing information as set forth in claim 1, wherein the service accesses non-XML compliant data.

6. A method of accessing information as set forth in claim 1, wherein the class is implemented with a struct data type.

7. A method of accessing information as set forth in claim 1, wherein the class is implemented with a struct data type including at least one member, wherein the at least one member is a struct data type.

8. A method of accessing information as set forth in claim 1, wherein the class is implemented with a class data type.

9. A method of accessing information as set forth in claim 1, wherein the class is implemented with a class data type including at least one member, wherein the at least one member is a class data type.

10. A method of accessing information as set forth in claim 1, wherein the class is implemented with a plurality of objects.

11. A method of accessing information as set forth in claim 1, wherein the service accesses data and formats the data using a struct data type, which is implemented in accordance with the class.

12. A method of accessing information as set forth in claim 1, wherein the service accesses data and formats the data using a class data type, which is implemented in accordance with the class.

13. A memory comprising:
Web Services Description Language compliant information, the Web Services Description Language compliant information including class information, the class information implemented with a structured data type defined by the class information.

14. A memory as set forth in claim 13, wherein the structured data type is a struct data type.

15. A memory as set forth in claim 13, wherein the structured data type is a class data type.

16. A memory as set forth in claim 13, wherein the Web Services Description Language compliant information is accessed by a client to operate services.

17. A method comprising the steps of:
receiving Web Services Description Language compliant information, the Web Services Description Language compliant information including a class;
generating a request to a Web Service in response to receiving the Web Services Description Language compliant information; and
receiving a response from the Web Service, the response including at least one object compliant with the class.

18. A method as set forth in claim 17, wherein the step of receiving the Web Services Description Language compliant information is performed in response to generating a request to a registry and identifying the Web Service in response to generating the request to the registry.

19. A method comprising the steps of:
receiving Web Services Description Language compliant information including a class;
operating a Web Service in response to receiving the Web Services Description Language compliant information including the class; and
generating at least one object implemented in accordance with the class in response to operating the Web Service.

20. A method as set forth in claim 19, wherein the step of operating the Web Service includes accessing non-XML compliant data and formatting the non-XML compliant data into at least one object implemented in accordance with the class.
